(19) United States
(12) Patent Application Publication
(10) Pub. No.: US 2026/0042793 A1
(43) Pub. Date: Feb. 12, 2026

(54) NOVEL LIGNIN COMPOSITIONS AND METHODS OF MAKING AND USING SAME

(71) Applicant: The Texas A&M University System, College Station, TX (US)

(72) Inventors: Joshua Shuhua Yuan, College Station, TX (US); Jinghao Li, Madison, WI (US); Susie Y. Dai, College Station, TX (US)

(21) Appl. No.: 19/101,580

(22) PCT Filed: Aug. 11, 2023
(86) PCT No.: PCT/US2023/072111

§ 371 Date: Feb. 5, 2025

Related U.S. Application Data
(60) Provisional application No. 63/371,184, filed on Aug. 11, 2022.

(51) Int. Cl. C07G 1/00; C08H 7/00; D01F 9/17

(52) U.S. Cl. CPC C07G 1/00; C08H 6/00; D01F 9/17; D10B 2101/12

(57) ABSTRACT

A method of producing a high molecular weight esterified lignin comprising contacting a lignin composition obtained from a renewable resource with an aqueous fluid a plurality of times to produce a washed lignin; contacting the washed lignin with an esterifying agent under conditions suitable for formation of an esterified lignin; contacting the esterified lignin with a crosslinking agent under conditions suitable for the formation of a high molecular weight esterified lignin; and recovering the high molecular weight esterified lignin. A composition comprising (i) a polymeric material and (ii) a high molecular weight esterified lignin. A carbon fiber prepared from (i) a polymeric material and (ii) a high molecular weight esterified lignin.

### CROSS-REFERENCE TO RELATED APPLICATIONS

This application is a 35 U.S.C. § 371 national stage application of PCT/US2023/072111 filed Aug. 11, 2023, and entitled “Novel Lignin Compositions and Methods of Making and Using Same,” which claims benefit of U.S. provisional patent application Ser. No. 63/371,184 filed Aug. 11, 2022, and entitled “Novel Lignin Compositions and Methods of Making and Using Same,” each of which is hereby incorporated herein by reference in its entirety for all purposes.

### STATEMENT REGARDING FEDERALLY SPONSORED RESEARCH OR DEVELOPMENT

This invention was made with government support by U.S. Department of Energy EE0008250 grant. The government has certain rights in the invention.

### TECHNICAL FIELD

The present disclosure relates generally to biosourced platform chemicals. More particularly, relates to novel lignin-based materials and methods of making and using same.

### BACKGROUND

Lignin is the second most abundant biopolymer on earth but there are significant challenges to broader utilization of this material in chemical manufacturing. Lignin-based fungible materials are important to the development of sustainable manufacturing of critical chemical compounds yet the heterogenous lignin structures remains challenging. An ongoing need exists for novel lignin materials that (i) can be manufactured with compositional consistence and (ii) possess or impart improved mechanical and/or chemical performance to compounds and/or materials.

### BRIEF DESCRIPTION OF THE DRAWINGS

For a detailed description of various exemplary aspects, reference will now be made to the accompanying drawings in which:

FIG. 1 is a schematic view of an aspect of a method producing a high molecular weight esterified linkage lignin (HIMWELL) in accordance with the principles described herein.

FIG. 2 is a graph presenting the results of ash content analysis of lignin samples raw Kraft lignin (RKL), Kraft lignin (KL), modified Kraft lignin (CTKL), and a HIMWELL.

FIGS. 3A-3D are photographs depicting the customized wet spinning system for lignin-based fiber where FIG. 3A illustrates the wet spinning system, FIG. 3B illustrates the lignin precursor dope in the syringe under micro-pumping, FIG. 3C illustrates the automatic winding system with heating element, and FIG. 3D illustrates the as-produced lignin-based fiber.

FIG. 4 depicts morphologies, EDX mapping and element analysis of RKL, KL, CTKL and HIMWELL samples

FIGS. 5A-5C depict high-resolution transmission electron microscopy (HRTEM) photographs showing carbon fiber sample preparation with focused ion beam scanning electron microscopy FIB/SEM. Specifically, FIG. 5A depicts cutting the lamella; FIG. 5B depicts mounting the lamella and; FIG. 5C depicts thinning the lamella.

FIG. 6 illustrates photographs of lignin-based plastic blends UV exposure testing and mechanical testing.

FIG. 7 is a graph of the tensile stress and Young's modulus of polymethyl methacrylate (PMMA), PMMA/10% KL and PMMA/10% HIMWELL films before UV exposure, after UV exposure, and after recyclization and regeneration.

### SUMMARY

A method of producing a high molecular weight esterified lignin comprising contacting a lignin composition obtained from a renewable resource with an aqueous fluid a plurality of times to produce a washed lignin; contacting the washed lignin with an esterifying agent under conditions suitable for formation of an esterified lignin; contacting the esterified lignin with a crosslinking agent under conditions suitable for the formation of a high molecular weight esterified lignin; and recovering the high molecular weight esterified lignin.

A composition comprising (i) a polymeric material and (ii) a high molecular weight esterified lignin.

A carbon fiber prepared from (i) a polymeric material and (ii) a high molecular weight esterified lignin.

### DETAILED DESCRIPTION

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Groups of elements of the periodic table are indicated using the numbering scheme indicated in the version of the periodic table of elements published in Chemical and Engineering News, 63 (5), 27, 1985. In some instances, a group of elements can be indicated using a common name assigned to the group; for example alkali earth metals (or alkali metals) for Group 1 elements, alkaline earth metals (or alkaline metals) for Group 2 elements, transition metals for Group 3-12 elements, and halogens for Group 17 elements.

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the subject matter described herein. A “consisting essentially of” claim occupies a middle ground between closed claims that are written in a “consisting of” format and fully open claims that are drafted in a “comprising” format. Absent an indication to the contrary, when describing a compound or composition “consisting essentially of” is not to be construed as “comprising,” but is intended to describe the recited component that includes materials which do not significantly alter the composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms “comprising.” “consisting essentially of,” and “consisting of” apply only to the feature class which is utilized and it is possible to have different transitional terms or phrases utilized with different features within a claim.

Within this specification, use of “comprising” or an equivalent expression contemplates the use of the phrase “consisting essentially of,” “consists essentially of,” or equivalent expressions as alternative aspects to the open-ended expression. Additionally, use of “comprising” or an equivalent expression or use of “consisting essentially of” in the specification contemplates the use of the phrase “consisting of,” “consists of,” or equivalent expressions as an alternative to the open-ended expression or middle ground expression, respectively. For example, “comprising” should be understood to include “consisting essentially of,” and “consisting of” as alternative aspects for the aspect, features, and/or elements presented in the specification unless specifically indicated otherwise.

While compositions and methods are described in terms of “comprising” various components or steps, the compositions and methods can also “consist essentially of” or “consist of” the various components or steps.

The terms “a,” “an,” and “the” are intended, unless specifically indicated otherwise, to include plural alternatives, e.g., at least one.

For any compound disclosed herein, the general structure or name presented is also intended to encompass all structural isomers, conformational isomers, and stereoisomers that can arise from a set of substituents, unless indicated otherwise. Thus, a general reference to a compound includes all structural isomers unless explicitly indicated otherwise; e.g., a general reference to pentane includes n-pentane, 2-methyl-butane, and 2,2-dimethylpropane while a general reference to a butyl group includes an n-butyl group, a sec-butyl group, an iso-butyl group, and a tert-butyl group. Additionally, the reference to a general structure or name encompasses all enantiomers, diastereomers, and other optical isomers whether in enantiomeric or racemic forms, as well as mixtures of stereoisomers, as the context permits or requires. For any particular formula or name that is presented, any general formula or name presented also encompasses all conformational isomers, regioisomers, and stereoisomers that can arise from a particular set of substituents.

Features within this disclosure that are provided as minimum values can be alternatively stated as “at least” or “greater than or equal to” any recited minimum value for the feature disclosed herein. Features within this disclosure that are provided as maximum values can be alternatively stated as “less than or equal to” for the feature disclosed herein.

Use of the term “optionally” with respect to any element of a claim is intended to mean that the subject element is required, or alternatively, is not required. Both alternatives are intended to be within the scope of the claim.

Processes described herein can utilize steps, features, compounds and/or equipment which are independently described herein. The processes described herein may or may not utilize step identifiers (e.g., 1), 2), etc., a), b), etc., i), ii), etc., or first, second, etc., among others), feature identifiers (e.g., 1), 2), etc., a), b), etc., i), ii), etc., or first, second, etc., among others), and/or compound and/or composition identifiers (e.g., 1), 2), etc., a), b), etc., i), ii), etc., or first, second, etc., among others). However, it should be noted that processes described herein can have multiple steps, features (e.g., reagent ratios, formation conditions, among other considerations), and/or multiple compounds and/or compositions using no descriptor or sometimes having the same general identifier. Consequently, it should be noted that the processes described herein can be modified to use an appropriate step or feature identifier (e.g., 1), 2), etc., a), b), etc., i), ii), etc., or first, second, etc., among others), feature identifier (e.g., 1), 2), etc., a), b), etc., i), ii), etc., or first, second, etc., among others), and/or compound identifier (e.g., first, second, etc.) regardless of step, feature, and/or compound identifier utilized in a particular aspect described herein and that step or feature identifiers can be added and/or modified to indicate individual different steps/features/compounds utilized within the processes without detracting from the general disclosure.

Disclosed herein are methods for producing novel lignin compositions. Lignin obtained from natural sources such as agricultural waste may be characterized as a mixture of lignin molecules having diverse linkages, heterogeneous functional groups, variable molecular weights, and the presence of amphiphilic structures. In other words, lignin obtained from natural sources is a mixture of lignin molecules with differing characteristics such as variable molecular weights and chemical functionalities resulting in a heterogeneity of lignin structures. Thus, the lignin obtained from natural sources may have a plurality of lignin structures which can be conceptualized as subpopulations of molecules having similar characteristics. For example, lignin obtained from natural sources may have a first set of lignin molecules with similar molecular weights (for e.g., the molecular weights of each member of the population are within +10% of each other) and/or a similar number and type of functionalities. In this example, the set can be designated N1. Lignin obtained from natural sources may have a second set of lignin structures with similar molecular weights and/or a similar number and type of functionalities and the population can be designated N2. Overall the lignin obtained from natural sources could be characterized as having some number (N) of lignin sets resulting in a heterogenous mixture of lignin structures.

Disclosed herein are lignin compositions chemically designed for increased homogeneity such that the number of different lignin sets within the composition are reduced when compared to the number of lignin sets obtained from a natural source. For example, the lignin obtained from a natural source may have N sets of lignin molecules while the lignin compositions of the present disclosure may have X sets of lignin molecules wherein X is from about 5% to about 50% less than N, alternatively from about 10% to about 50% less than N or alternatively from about 25% to about 50% less than N. Thus, the lignin compositions disclosed herein display an increased homogeneity when compared to the lignin compositions obtained from a natural source.

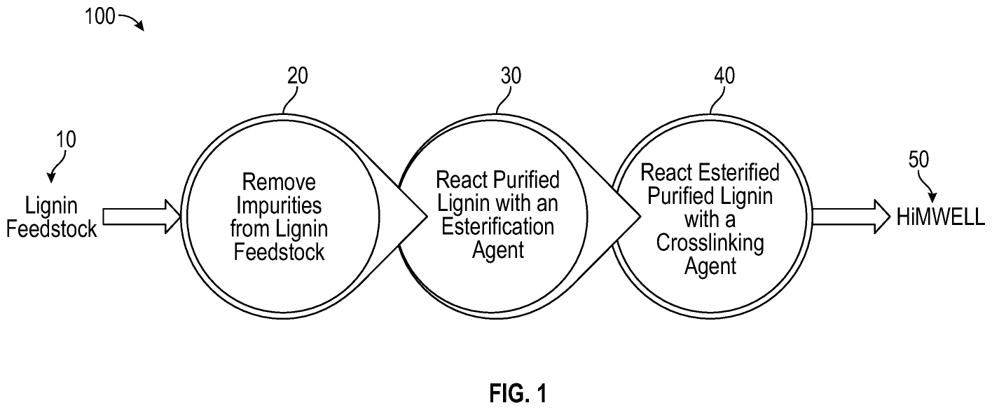

The lignin products of the present disclosure are characterized by a compositional uniformity which includes the presence of an increased homogeneity in chemical linkages, functional groups, molecular weights and the absence of amphiphilic structures when compared to an original lignin feedstock. The lignin product generated as disclosed herein is a high molecular weight esterified linkage lignin and designated a HIMWELL. In an aspect, a method of producing a HIMWELL of the present disclosure is depicted in FIG. 1. With reference to FIG. 1, a method for producing a HIMWELL 100 comprises (i) reducing the impurities of the lignin feedstock 10 to generate a purified lignin 20; (ii) contacting the purified lignin 20 with an esterifying agent to form an esterified purified lignin 30; and crosslinking the esterified purified lignin with a crosslinking agent 40 to generate a lignin product of the present disclosure 50.

In an aspect, the lignin feedstock, also referred to herein as the original lignin feedstock, may be obtained from any suitable biomass and may comprise any lignocellulosic material. Nonlimiting examples of lignocellulosic material suitable for use in the present disclosure include hard or soft wood, grasses, agricultural waste, agricultural material, municipal waste, or a combination of one or more biomasses. In one or more aspects, agricultural material or waste which may be used as the lignin feedstock comprises corn stover, corn cobs, corn kernels, corn fibers, straw, banana plantation waste, rice straw, rice hull, oat straw, oat hull, com fiber, cotton stalk, cotton gin, wheat straw, sugar cane bagasse, sugar cane trash, sorghum residues, sugar processing residues, barley straw, cereal straw, wheat straw, canola straw, soybean stover, and combinations thereof.

The processes and systems of the present disclosure for production of a HIMWELL can accommodate a wide range of feedstocks of various types, sizes, and moisture contents. For example, biomass such as forest products, grasses, and other cellulosic material may be used. In an aspect, the lignin feedstock comprises agricultural waste, alternatively the lignin feedstock comprises lignin obtained from a pulping process such as Kraft lignin. In an aspect, the lignin used in the present disclosure is derived from biorefinery waste, pulping waste, fermentation waste or a combination thereof.

In one or more aspects, the original feedstock is pretreated. Nonlimiting examples methods of pretreating the original feedstock include thermo-chemical, enzymatic hydrolysis, (3) microbial fermentation, product separation, deacetylation and mechanical refining (DMR); ammonia finer expansion (AFEX) pretreatment and combinations thereof. AFEX refers to a process where liquid ammonia contacted with a lignin-containing biomass under moderate pressure (e.g., 100 psi to 400 psi) and temperature (70° C. to 200° C.) before rapidly releasing the pressure. Without wishing to be limited by theory, pretreatment may help to open up the cell wall, increasing the accessibility of various agents.

In one or more aspects, a method of the present disclosure comprises reducing the impurities of the lignin feedstock. Without wishing to be limited by theory, impurities that may be found in a lignin feedstock derived from sources such as a pulping process or biorefinery fermentation typically include water soluble chemicals such as alkalis, acids, enzymes, or salts which were used to react or facilitate lignocellulosic processes. These chemicals remain as extra residual impurities in the lignin precipitate.

Any suitable methodology may be utilized to reduce the level of impurities in a lignin feedstock. In one or more aspects, a method of the present disclosure comprises a solvent purification step. Specifically, the level of impurities in the lignin feedstock may be reduced by contacting the lignin feedstock with an aqueous fluid, alternatively with water, or alternatively with deionized (DI) water. For example, the lignin feedstock may be contacted with excess DI water a plurality of times, designated y, where y may range from about 1 to about 5 times, alternatively from about 1 to about 4, alternatively from about 2 to about 4 or alternatively from about 3 to about 5. The resultant materials is a washed lignin feedstock.

A method of purifying an original lignin feedstock may further comprise thermal treatment of the washed lignin feedstock to remove remaining moisture. In one or more aspects, the washed lignin feedstock is heated to a temperature of from about 95° C. to 110° C. alternatively from about 100° C. to about 105° C., alternatively from about 95° C. to about 100° C. or alternatively from about 105° C. to about 110° C. for a time period of from about 30 mins to about 240 mins, alternatively from about 30 mins to about 60 mins, alternatively from about 60 mins to about 120 mins or alternatively from about 120 mins to about 240 mins. The resulting material is termed a purified lignin and may have an ash content reduced by from about 0.5% to about 20%, alternatively from about 0.5% to about 5%, alternatively from about 1% to about 10% or alternatively from about 1% to about 20% when compared to the original lignin feedstock based on the weight of ash in the original lignin when compared to the weight of ash present in the purified lignin. Herein the ash content refers to the gravimetrically determined residue after ignition at a defined temperature, in a sample, in percent (weight/weight dry matter of sample). In the determination, a sample is weighed in a heat-resistant crucible, dried at 105±2° C., and ignited in a muffle furnace at 525±25° C. The ash content is then determined, on a moisture-free basis, from the weight of residue after ignition and the moisture content of the sample.

In one or more aspects, a method of the present disclosure comprises esterification of the purified lignin. Any material capable of esterification of the purified lignin and compatible with the other components of the material may be used to esterify the purified lignin. In one or more aspects, the purified lignin is esterified by reaction with an anhydride, alternatively an organic anhydride.

Nonlimiting examples of organic anhydrides suitable for use in the esterification of the purified lignin include acetic anhydride, octanoic acid anhydride, n-octanoic anhydride, caprylic anhydride, n-caprylic anhydride, propionic anhydride, crotonic anhydride and a combination thereof. In an aspect, the organic anhydride comprises crotonic anhydride.

In one or more aspects of the methods disclosed herein, the purified lignin is reacted with an organic anhydride (e.g., crotonic anhydride) in the presence of a suitable catalyst and solvent (e.g., DMF, 1,4 dioxane) at a temperature of from about 120° C. to about 180° C., alternatively from about 120° C. to about 140° C., alternatively from about 140° C. to about 160° C. or alternatively from about 160° C. to about 180° C. for a time period of from about 0.5 hours to about 8 hours, 0.5 hours to about 1 hour, alternatively from about 1 hour to about 4 or alternatively from about 4 hours to about 8 hours. A catalyst suitable for use in the present disclosure may be a hypernucleophilic acylation catalyst such as chiral bicyclic amidines and isothioureas (e.g., 4-dimethylaminopyridine). The organic anhydride may be present in the hypernucleophilic acylation reaction mixture in an amount of from about 10 weight percent (wt. %) to about 60 wt. %, alternatively from about 10 wt. % to about 20 wt. %, alternatively from about 20 wt. % to about 40 wt. % or alternatively from about 40 wt. % to about 60 wt. %. The resultant product is termed an esterified purified lignin.

In one or more aspects, a method of the present disclosure further comprises reacting the esterified purified ligand with a crosslinking agent. Prior to crosslinking of the esterified purified lignin, the product of the reaction with an organic anhydride may be processed to meet one or more user and/or process goals. For example, prior to crosslinking of the esterified purified lignin, the product of the organic anhydride reaction may be subjected to one or more processes for purification such as filtration. For example, lignin after biorefinery procedures, carbon fiber manufacturing, lignin derived from acid and alkaline combined pretreatment, lignin derived from fermentation residual, or combinations thereof can be used for carbon fiber manufacturing using HIMWELL.

Nonlimiting examples of crosslinking agents suitable for use in the present disclosure include 1-ethyl-3-[3-dimethylaminopropyl]carbodiimide hydrochloride (EDC), dicyclohexyl carbodiimide (DDC), N-hydroxysuccinimide esters (NHS), maleimides, or a combination thereof. The crosslinking agent may be present in an amount of from about 1 wt. % to about 10 wt. %, alternatively from about 1 wt. % to about 3 wt. %, alternatively from about 3 wt. % to about 6 wt. % or alternatively from about 6 wt. % to about 10 wt. % based on the total amount of esterified purified lignin.

The esterified purified lignin may be contacted with the crosslinking agent at a temperature of from about 120° C. to about 180° C., alternatively from about 120° C. to about 140° C., alternatively from about 140° C. to about 160° C. or alternatively from about 160° C. to about 180° C. for a time period of from about 0.5 hours to about 8 hours, alternatively from about 0.5 hours to about 1 hour, alternatively from about 1 to about 4 hours or alternatively from about 4 hours to about 8 hours in a solvent of DMF or 1,4 dioxane. The resulting material is a HIMWELL.

In an aspect, a HIMWELL of the present disclosure is characterized by a molecular weight of from about 4000 g/mol to about 20000 g/mol, alternatively from about 4000 g/mol to about 12000 g/mol, alternatively from about 4000 g/mol to about 8000 g/mol, alternatively from about 8000 g/mol to about 12000 g/mol or alternatively from about 12000 g/mol to about 16000 g/mol as determined using any suitable methodology such as GPC.

In one or more aspects, a HIMWELL is characterized by a hydroxyl group content that is reduced by from about 0.3 mmol/g to about 10 mmol/g, alternatively form about 1 mmol/g to about 10 mmol/g, alternatively from about 0.5 mmol/g to about 5 mmol/g or alternatively from about 0.3 mmol/g to about 3 mmol/g when compared to the lignin feedstock.

In one or more aspects, a HIMWELL may be included with one or more polymers to form compositional blends that displayed improved properties (e.g., mechanical properties) when compared to the polymer in the absence of a HIMWELL. Any polymer compatible with the HIMWELL may be used to form a compositional blend. Nonlimiting examples of polymers that may be used to form the compositional blend include low-density polyethylene (LDPE), high-density polyethylene (HDPE), polypropylene (PP), polyvinyl chloride (PVC), polystyrene (PS), polytetrafluoroethylene, thermoplastic polyurethanes (TPU), polyacrylonitrile and combinations thereof.

Without wishing to be limited by theory the dissolution pattern and molecular morphology of the HIMWELL lignin may be attributable to the formation of aggregate lignin molecules suggesting the hydrophobic interaction of the HIMWELL lignin molecule to form more compact structures. A HIMWELL having a less amorphous structure and more hydrophobicity could improve the miscibility of HIMWELL with polymers such as polyacrylonitrile (PAN).

In one or more aspects, a HIMWELL of the type disclosed herein is blended with PAN, and the blend designated a HIMWELL-PAN. HIMWELL-PAN compositions may be characterized by (i) an increased shear viscosity in comparison with PAN dope and (ii) a non-Newtonian behavior of the shear thinning behavior. Without wishing to be limited by theory, HIMWELL-PAN compositions may have a strong interaction between the lignin and PAN molecules and the shear thinning effect could be caused by the altered functional groups and larger molecule of the HIMWELL. Particularly, HIMWELL may reduce the extent of entanglement of the PAN molecule causing rearrangement of the PAN molecule to a more aligned structure. The resulting HIMWELL-PAN blend having improved alignment due to the presence of compact molecules may improve the microstructure and consequently performance properties of end-use articles prepared from the blend. In some aspects, the structural changes due to the interaction of HIMWELL and PAN could also help to produce improved as-spun fibers with smaller diameters, more uniform structures, and fewer defects.

In one or more aspects, a HIMWELL-PAN may be formed by the combining of HIMWELL and PAN in a ratio of from about 1:99 to about 99:1, alternatively from about 50:50 to about 10:90, alternatively from about 50:50 to about 90:10 or alternatively from about 50:50 to about 99:1.

In one or more aspects, a HiMWELL-PAN is utilized in the production of carbon fiber. For example, the HIMWELL-PAN may be converted into fibers using any suitable methodology, such as a wet spinning system. The as-spun fibers may then be thermostabilized by thermal treating of the fibers at a temperature of from about 200° C. to about 350° C., alternatively from about 200° C. to about 250° C., alternatively from about 250° C. to about 300° C. or alternatively from about 300° C. to about 350° C. for a time period of from about 1 hour to about 5 hours to form thermostablized HIMWELL-PAN carbon fibers. The thermostablized HIMWELL-PAN carbon fibers can then be carbonized by thermally treating the fibers at a temperature of from about 1000° C. to about 3000° C., alternatively from about 1000° C. to about 1500° C., alternatively from about 1500° C. to about 2000° C. or alternatively from about 2000° C. to about 2500° C. for a time period of from about 1 hour to about 10 hours to form the carbon fiber.

In one or more aspects, HIMWELL-PAN carbon fibers display improved mechanical properties. For example, the HIMWELL-PAN carbon fibers may have a tensile strength at break of from about 0.5 GPa to about 2 GPa, alternatively from about 0.5 GPa to about 1 GPa, alternatively from 1 GPa to about 1.5 GPa or alternatively from about 1.5 GPa to about 2 GPa as determined in accordance with ISO37. Tensile strength (TS) at break measures the maximum stress a plastic specimen can withstand while being stretched before breaking.

In one or more aspects, HIMWELL-PAN carbon fibers may have a Young's modulus of from about 1 gigapascal (GPa) to about 3 GPa, alternatively from about 1.5 GPa GPa to about 3.0 GPa, or alternatively from about 2.0 GPa to about 3.0 as determined in accordance with ISO37. In one or more aspects, the HIMWELL-PAN carbon demonstrates mechanical properties such as a tensile strength or Young's modulus that is increased by from about 10% to about 50% or alternatively greater than about 25% when compared to the carbon fiber prepared in the absence of a HIMWELL.

Young's modulus also referred to as the modulus of elasticity is a measure of the relationship of an applied stress to the resultant strain. The Young's modulus is an elastic constant that demonstrates the ability of the tested material to withstand applied loads. A number of different laboratory techniques may be used to measure the Young's modulus of a treatment fluid including the composition after the treatment fluid has been allowed to set for a period of time at specified temperature and pressure conditions.

In one or more aspects, the HIMWELL-PAN carbon fibers are characterized by an electrical conductivity of from about 30000 s/m to about 100000 s/m, alternatively 30000s/m to about 50000 s/m, alternatively from about 50000 s/m to about 70000 s/m or alternatively from about 70000 s/m to about 100000 s/m as determined by the fiber diameter.

In one or more aspects, the HIMWELL functions as a precursor for carbon fiber and recyclable plastics. In other aspects, the HIMWELL functions as a performance-enhancing additive for virgin polymer materials. HIMWELL may find utility as a precursor for carbon-based materials, bioplastics, nanomaterials, additives, construction and pavement materials and the like.

Disclosed herein are methods for the preparation of a HIMWELL having increased homogeneity when compared to the feedstock used in the production of the HIMWELL. The lignin compositions of this disclosure (HIMWELL) was chemically designed to reduce the disparity in chemical structures found in the original lignin feedstock. The method for chemical design disclosed herein takes into consideration three steps that impact lignin properties, and therefore impact the miscibility, spinnability, uniformity, molecular weight, and crystallite structure of the advanced carbon fiber products. The first step was lignin purification. During the pulping process or biorefinery fermentation, excess chemicals such as alkalis, acids, enzymes, or salts are used to react or facilitate lignocellulosic processes, thus the extra residual impurities remain in the lignin precipitate that have negative effects on the lignin performance, especially for fine products such as lignin-based carbon fiber. The volatile impurities in the lignin evaporate during the fiber stabilization process causing undesired voids and defects in the carbon fiber, significantly reducing the performance of lignin-based carbon fiber. Meanwhile, the other non-volatile impurities in the lignin such as sodium salts or other metal salts catalyze the carbon element of lignin under high temperature during the carbonization process, disrupting the arrangement of carbon molecules and disorganizing the crystallite structural formation of carbon fiber graphitization. Furthermore, another category: In one or more aspects, a HIMWELL functions as an additive for the carbon fiber manufacturing to increase crystallite content and performance.

Having described various compositions, methods, and applications, various aspects can include, but are not limited to:

A first aspect which is a method of producing a high molecular weight esterified lignin comprising contacting a lignin composition obtained from a renewable resource with an aqueous fluid a plurality of times to produce a washed lignin; contacting the washed lignin with an esterifying agent under conditions suitable for formation of an esterified lignin; contacting the esterified lignin with a crosslinking agent under conditions suitable for the formation of a high molecular weight esterified lignin; and recovering the high molecular weight esterified lignin.

A second aspect which is the method of the first aspect wherein the lignin composition obtained from a renewable resource comprises corn stover, corn cobs, corn kernels, corn fibers, straw, banana plantation waste, rice straw, rice hull, oat straw, oat hull, corn fiber, cotton stalk, cotton gin, wheat straw, sugar cane bagasse, sugar cane trash, sorghum residues, sugar processing residues, barley straw, cereal straw, wheat straw, canola straw, soybean stover, or a combination thereof.

A third aspect which is the method of any of the first through second aspects wherein the lignin composition obtained from a renewable resource comprises Kraft lignin, hard or soft wood, grasses, agricultural waste, agricultural material, municipal waste, or a combination thereof.

A fourth aspect which is the method of any of the first through third aspects wherein the lignin composition obtained from a renewable resource is obtained from biorefinery waste, pulping waste, fermentation waste or a combination thereof.

A fifth aspect which is the method of any of the first through fourth aspects further comprising pretreating the lignin composition obtained from a renewable resource.

A sixth aspect which is the method of the fifth aspect wherein pretreating comprises thermo-chemical pretreatment, enzymatic hydrolysis, microbial fermentation, product separation, deacetylation and mechanical refining (DMR) pretreatment, ammonia fiber expansion (AFEX) pretreatment or combinations thereof.

A seventh aspect which is the method of any of the first through sixth aspects wherein the lignin composition obtained from a renewable resource comprises Kraft lignin.

An eighth aspect which is the method of any of the first through seventh aspects wherein the plurality of times is from about 1 to about 5.

A ninth aspect which is the method of any of the first through eighth aspects wherein the esterifying agent is an organic anhydride.

A tenth aspect which is the method of any of the first through ninth aspects wherein the organic anhydride comprises acetic anhydride, octanoic acid anhydride, n-octanoic anhydride, caprylic anhydride, n-caprylic anhydride, propionic anhydride, crotonic anhydride or a combination thereof.

An eleventh aspect which is the method of any of the first through tenth aspects wherein the crosslinking agent comprises 1-ethyl-3-[3-dimethylaminopropyl]carbodiimide hydrochloride (EDC), dicyclohexyl carbodiimide (DDC), N-hydroxysuccinimide esters (NHS), maleimides, or a combination thereof.

A twelfth aspect which is the method of any of the first through eleventh aspects wherein the high molecular weight esterified lignin has a molecular weight of from about 4000 g/mol to about 20000 g/mol.

A thirteenth aspect which is the method of any of the first through twelfth aspects wherein the high molecular weight esterified lignin has a hydroxyl group content that is reduced by from about 0.3 mmol/g to about 10 mmol/g when compared the lignin composition obtained from a renewable resource.

A fourteenth aspect which is a composition comprising (i) a polymeric material and (ii) a high molecular weight esterified lignin.

A fifteenth aspect which the composition of the fourteenth aspect wherein the polymeric material comprises low-density polyethylene (LDPE), high-density polyethylene (HDPE), polypropylene (PP), polyvinyl chloride (PVC), polystyrene (PS), polytetrafluoroethylene, thermoplastic polyurethanes (TPU), polyacrylonitrile or combinations thereof.

A sixteenth aspect which is the composition of any of the fourteenth through fifteenth aspects wherein the polymeric material comprises low-density polyethylene (LDPE), high-density polyethylene (HDPE), polypropylene (PP), polyvinyl chloride (PVC), polystyrene (PS), polytetrafluoroethylene, thermoplastic polyurethanes (TPU), polyacrylonitrile or combinations thereof.

A seventeenth aspect which is the composition of any of the fourteenth through sixteenth aspects wherein the polymeric material comprises polyacrylonitrile.

An eighteenth aspect which is the composition of any of the fourteenth through seventeenth aspects wherein the high molecular weight esterified lignin has a molecular weight of from about 4000 g/mol to about 20000 g/mol.

A nineteenth aspect which is the composition of any of the fourteenth through eighteenth aspects wherein the high molecular weight esterified lignin has a hydroxyl group content that is reduced by from about 0.3 mmol/g to about 10 mmol/g when compared the lignin composition obtained from a renewable resource.

A twentieth aspect which is a carbon fiber prepared from (i) a polymeric material and (ii) a high molecular weight esterified lignin.

A twenty-first aspect which is the carbon fiber of the twentieth aspect wherein the polymeric material comprises polyacrylonitrile.

A twenty-second aspect which is the carbon fiber of any of the twentieth through twenty-first aspects wherein the high molecular weight esterified lignin has a molecular weight of from about 4000 g/mol to about 20000 g/mol.

A twenty-third aspect which is the carbon fiber of any of the twentieth through twenty-second aspects wherein the carbon fiber has a Young's modulus of from about 1 GPa to about 3 GPa.

A twenty-fourth aspect which is the carbon fiber of any of the twentieth through twenty-third aspects wherein the carbon fiber has a tensile strength of from about 0.5 GPa to about 2 GPa.

A twenty-fifth aspect which is an article prepared from the carbon fiber of the twentieth aspect.

### EXAMPLES

The presently disclosed subject matter having been generally described, the following examples are given as particular aspects of the subject matter and to demonstrate the practice and advantages thereof. It is understood that the examples are given by way of illustration and are not intended to limit the specification or the claims in any manner. In the following examples, percentages refer to weight percent based on the total weight of the sample being described unless indicated otherwise.

### Example 1

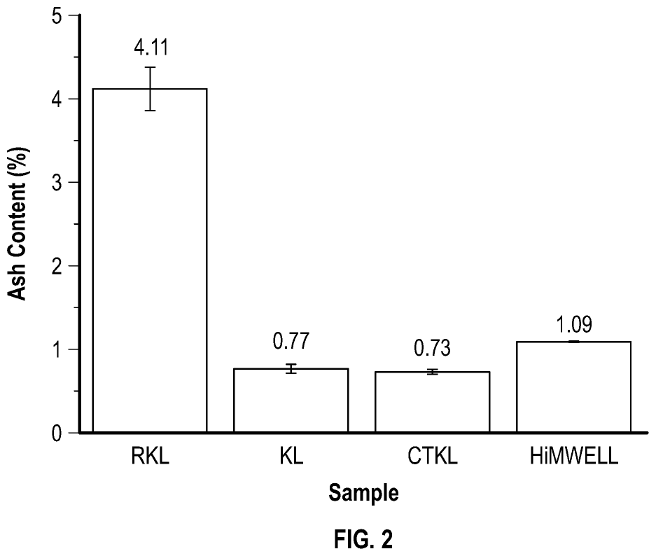

Methods of purifying lignin for use in the preparation of a HIMWELL was investigated. Specifically, a solvent purification step was employed to purify the lignin and remove the salts. Several organic solvents such as methanol, acetone, and ethyl acetate, etc. were used to wash the lignin in the preliminary study. However, the result showed that these solvents can fractionate the lignin but not purify as the ash content increased compared with the original lignin. Then DI water was used to purify lignin due to the high solubility of the salts such as sodium chloride, potassium carbonate, etc. in water compared to the previous organic solvents. The Raw Kraft lignin (RKL) was then cleaned with DI water followed by heating lignin at 105° C. for 24 hours to remove remaining moisture. As shown in FIG. 2, RKL contains 4.11 wt. % ash, whereas the ash content of KL was reduced to 0.77 wt. %, representing a significant 85% reduction.

### Lignin Functional Group Design

The second step was lignin functional groups modification. Dried lignin was found to have hydrophilic groups contained 3 wt. %-6 wt. % moisture. The lignin was dried at 105° C. for 24 hours to minimize this effect. However, with completely dried lignin, the lignin absorbed water from the ambient humidity and went back up to 5%, which might cause micropores in the fiber during the stabilization process.

These micropores resulted in stress concentration which significantly reduced the strength of the lignin-based carbon fiber. Meanwhile, it was found that functional groups such as the hydroxyl group in the lignin backbone might transfer to gases during the thermal process, which might cause extra voids or defects, reducing the mechanical performance of lignin-based carbon fiber. In addition, the lignin amphiphilic property reduced the miscibility, especially when mixing with hydrophobic guest polymers such as PAN. Therefore, a method to address these issues was developed and tried to change lignin's functional groups from hydrophilic groups to hydrophobic groups. Organic anhydrides were able to successfully change the lignin nature and modify the lignin's hydrophilic functional groups. Crotonic anhydride was used as a model to optimize lignin chemical structure.

### Molecular Interlinking Reaction

The third step was increasing the lignin molecular weight. The glass transition temperature (Tg) of both modified lignin samples of CTKL and HIMWELL was affected by the chemical design, which can be adjusted by the reaction parameters. CTKL is a type of lignin synthesized with different esterified substructures when compared with KL. Overall, the optimized temperature and reaction parameters for producing the HIMWELL were evaluated to ensure both good solubility and miscibility of HIMWELL for the promising performance of advanced lignin-based carbon fiber. The optimal temperature for interlinking of the C═C bond in CTKL lignin was 130° C.

### Carbon Fiber Processing and Manufacturing

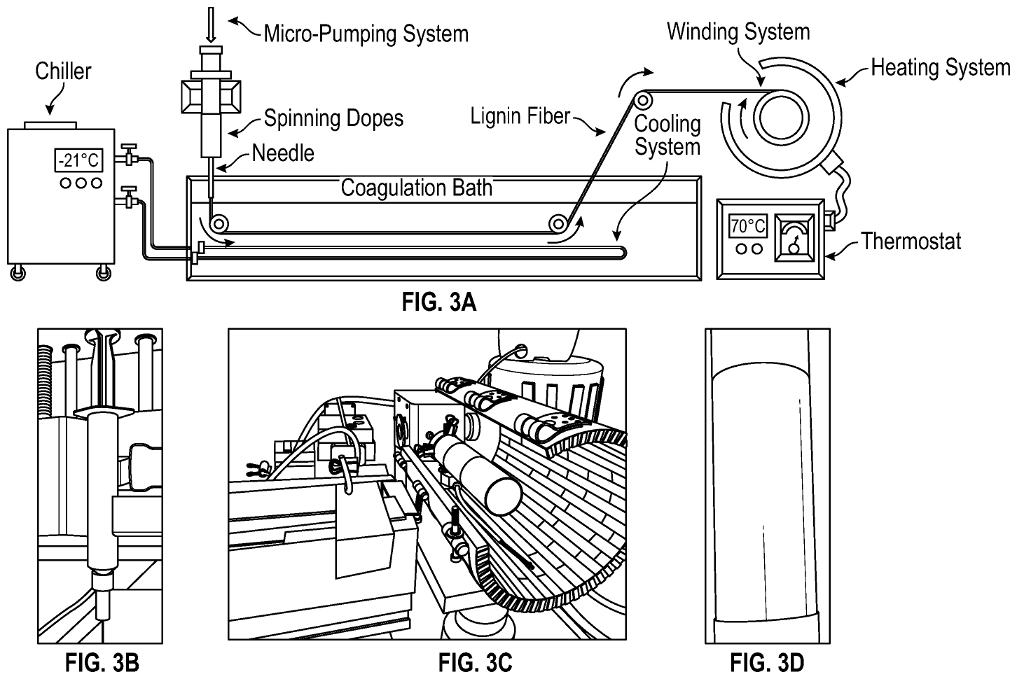

The precursor fiber spinning process is shown in FIGS. 3A-3D. Briefly, the lignin sample was spun into fibers by a customized wet spinning system. Lignin powders were first mixed with PAN at a weight ratio of 1:1, and then the mixture was dissolved in dimethylformamide (DMF) with 10% concentration. Lignin/PAN precursor was mixed by magnetic stirrer for 5 hours and then sonicated using a BRANSON 1510 sonicator for 60 mins before spinning to remove existing air bubbles. The precursor was then injected into a methanol coagulation bath (−5° C.) by a 32G needle at a rate of 0.1 mL/min to spin fibers in a customized wet-spinning system with humidity control. As-spun fibers were wound onto a rolling drum at a rate of 10 m/min. After washing with water, the fibers were cut and hung for drying.

As-spun lignin precursor fibers were thermostabilized and then carbonized into lignin-based carbon fibers. The thermostabilizing was carried out using a muffle furnace (GSL 1200X, MTI Corporation, Richmond, CA) under air. The thermostabilization process was from room temperature to 250° C. at a heating rate of 1° C./min and holding at 250° C. for 1 hour. The thermostabilized fibers then underwent carbonization in a tube furnace with a vacuum system under a nitrogen atmosphere (60 mL/min) (GSL 1600X, MTI Corporation, Richmond, CA). The temperature for carbonization was increased with a heating rate of 5° C./min from room temperature to 1500° C. and held for 1h before naturally cooling down.”

### Materials and Precursors Characterizations

GPC was performed with a TOSOH HLC-8320 GPC using a refractive index detector and equipped with a TSKGEL SuperHZ4000 column. Experiments were performed at 30° C. with DMF solvent as the mobile phase (0.2 mL/min flow rate). Molecular weights are reported relative to polystyrene standards.

All the NMR experiments (³¹P, 1H, and HSQC) were performed on a Bruker ASCEND™ 500 MHz spectrometer equipped with a 5-mm N2 cryogenically cooled Broadband Observe (BBO) H&F probe. To measure the contents of hydroxyl groups in lignin, ³¹P NMR spectra were acquired after dissolving lignin (˜30 mg, dry weight) in a 0.5 mL pyridine/CDCls (1.6/1.0, v/v) solution and derivatizing with ˜75-100 μL 2-chloro-4,4,5,5-tetramethyl-1,3,2-dioxaphospholane (TMDP). Chromium acetylacetonate and endo-N-hydroxy-5-norbornene-2,3-dicarboximide (NHND) were also added into the solution as the relaxation agent and internal standard, respectively. The ³¹P spectra was acquired using an inverse-gated decoupling (Waltz-16) pulse sequence with a 25 s pulse delay and 64 scans. ˜ 50 mg dry lignin samples were dissolved in de-DMSO for HSQC and ¹H NMR experiments. A standard BRUKER heteronuclear single quantum coherence pulse sequence (hsqcetgp) was used for HSQC NMR under the following conditions: 220 ppm spectral width in F1 (¹³C) dimension with 256 data points and 12 ppm spectral width in F2 (1H) dimension with 1024 data points, a 90° pulse, a JCH of 145 Hz, a 1.0 s pulse delay, and 64 scans. ¹H NMR spectra were collected with a 1 s relaxation delay and 128 scans. All the data was processed using the TOPSPIN 2.1 software (Bruker BioSpin).

Lignin samples were analyzed using a Nicolet i50 FTIR spectrometer. All lignin and PAN powders were dried for two days in a vacuum-drier before measurement. FTIR spectra of all powders were collected using an attenuated total reflection (ATR) stage. Samples were loaded in ATR crystal. All samples were scanned 64 times and acquired at a spectral resolution of 4 cm⁻¹. The lignin water suspensions were placed on the glass plate with glass cover then observed under an DXS 500 (Olympus) optical Microscope. The morphologies of raw Kraft lignin and HIMWELL samples in the water solution were obtained, respectively.

The DSC was conducted using a TA Q2500 system (TA Instruments, New Castle, DE) under an N₂ atmosphere. Three milligram of lignin samples were placed in a sample pan and then heated from 0° C. to 250° C. at a heating and cooling rate of 10° C./min. The glass transition temperature (Tg) was derived of analysis.

Thermal stability and ash analysis of PAN and lignin were assessed by TGA (PerkinElmer Thermogravimetric Analyzer, PYRIS 1 TGA). For the thermogravimetric analysis, samples (1-3 mg) were heated from 50° C. to 800° C. at a rate of 10° C./min under a flow rate of 20 mL/min nitrogen at atmospheric conditions. For the ash analysis, samples (1-3 mg) were heated from 50° C. to 800° C. at a rate of 20° C./min and kept for 180 mins under a flow rate of 20 mL/min air at atmospheric conditions

The rheology analysis of the carbon fiber precursor dopes was performed by TA instruments DHR-2 Rheometer with 40 mm diameter parallel plate geometry. The sample thickness was 0.5 mm, and the test was conducted with the angular frequency of 10.0 rad/s at 25° C. Three replicates for each sample were performed for this test.

### Carbon Fiber Characterization and Testing

The PAN and lignin-based carbon fiber powders were mounted on a glass slide for Raman measurement, respectively. The Raman spectra was taken under a Horiba Jobin-Yvon LabRam HR Raman Confocal Microscope with 785 nm laser, 10× magnification of objective lens, D0.3 filter, 250 μm confocal pinhole, 10 s exposure time, and 10 accumulations. The intensity D/G ratios was calculated from the ratios of D band (1326 cm⁻¹) and G band (1586 cm⁻¹) by the software Origin 8.

The crystallite structure of carbon fiber was analyzed by a Bruker D8 Discovery XRD. The sample was placed in the sample holder of a two-circle goniometer, enclosed in a radiation safety enclosure. The X-ray source was a 2.2 kW Cu X-ray tube, maintained at an operating current of 40 kV and 40 mA. The crystalline size (Lhki) was calculated from (002) panel around 2θ of 24.5° by using Scherrer equation: L=KΔ/βcosθ, where L is the crystalline size, nm; K is shape factor, set as 0.94; λ is the X-ray wavelength (1.542 Å); θ is the Bragg angle in degrees; B is the full width at half maximum (FWHM) in radians. The distance between two crystalline lattices (dₕₖₗ) was estimated by using Bragg's law: 2dsinθ =nλ, where θ is the Bragg angle in degrees; n is set as 1; d is distance in nm.

The mechanical properties of carbon fibers were measured by a TestResources universal mechanical tester (Shakopee, MN). Carbon fibers were mounted on a sample holder made of paper board, which was then fixed with two grippers. For the measurement, a 2 N load cell with the resolution of 0.0001 N was used and the displacement rate was set at 0.200 mm/min. The original length (L) of fibers was measured using a vernier caliper, and the diameter and area (A) of the fibers were measured using field emission scanning electron microscopy (FE-SEM) and analyzed by ImageJ software. For each sample, ten different replicates were measured to get an average and standard derivation.

The electrical conductivity of the carbon fibers was measured by a FLUKE 87 TRUE RMS multimeter. Briefly, a single fiber was fixed by copper paint (GC Electronics) onto a cover glass slide, and then the electrical resistance (R, Ω) of the fiber between two copper paints was measured with the multimeter at ambient atmosphere. The electrical conductivity (σ, S/m) was calculated by the equation of σ=1/ρ=L/(R×A), where ρ is electrical resistivity (Ω·m), L (m) and A (m²) are the length and the cross-section area of each fiber, respectively. The length (L) of the fiber was measured by using the vernier caliper. For the cross-sectional area (A) of each fiber, the diameter of fiber was measured by the SEM and analyzed using ImageJ software. For each sample, ten different replicates were measured to get an average and standard derivation.

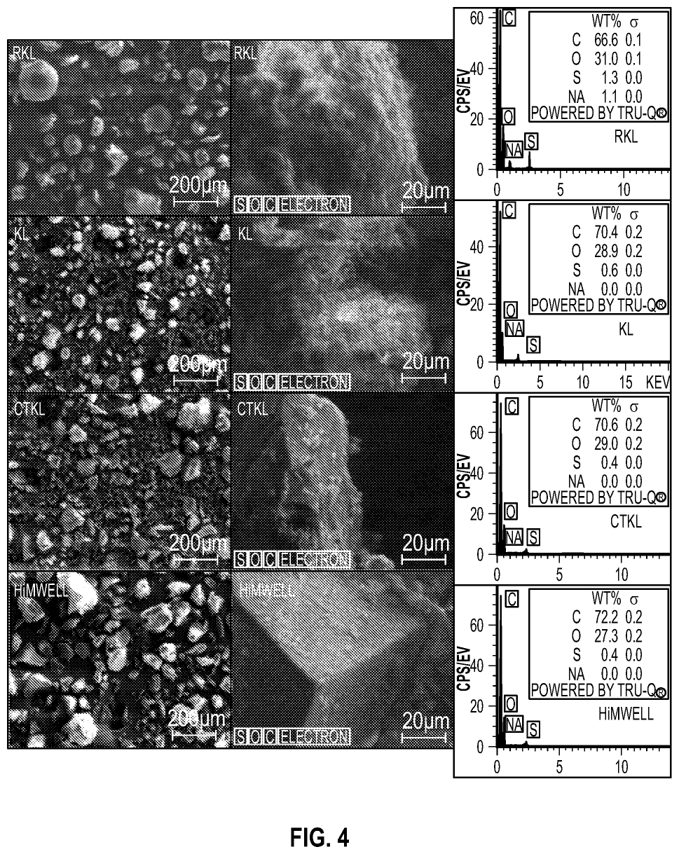

For morphology analysis and diameter measurement, carbon fibers were mounted on the plate with carbon tape and then observed under an ESCAN LYRA-3 Model GMH Focused Ion Beam Microscope with EDX. The working distance was 9 mm, and the accelerating voltage applied was 5 kV. The morphologies of carbon fibers surfaces and the morphologies of carbon fibers cross sections were shown in FIG. 4.

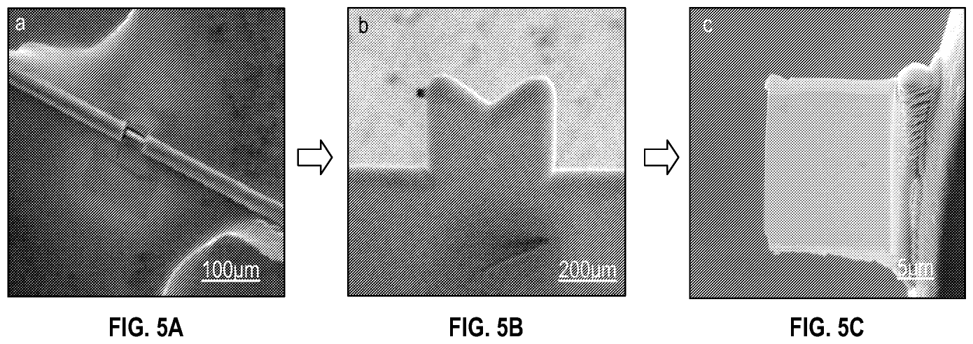

The high-resolution transmission electron microscopy (HRTEM) (Titan Themis³ 300 S/TEM) was used to analyze the microstructure and crystalline region of carbon fibers. The samples were prepared using a ESCAN LYRA-3 Model GMH Ga⁺Focused Ion Beam Microscope with a standard FIB lift-out technique. The ion beam was used to prepare around 100 nm thickness lamellas for TEM observation (FIGS. 5A-5C). HRTEM was performed at 300 KV to observe the samples.

### Sustainable Lignin-Based Plastic Fabrication

The 4.5g of commercial polymethyl methacrylate (PMMA) pellets were added to 10 ml N,N-dimethyl formamide (DMF), and stirred at 60° C. for 1 hour. For the PMMA-lignin blend, 10% wt KL powder and 5%, 10% and 20% HIMWELL powder were added, and stirred at 60° C. for an additional 1 hour, respectively. All samples were dried in a vacuum oven for 24 hours in aluminum plates before heat press. Dried samples were cut and heat pressed under 150° C. for 10 mins before pressed under cold press for another 10 mins. The as-produced samples were stored in the condition room at 23° C. and 50% humidity for further testing. For the recyclability, after the plastic blend films exposed under ultraviolet radiation for 100 hours at ambient temperature of 23±0.5° C. and relative humidity (RH) of 50±2%, the plastic blend films were reproduced by melting process. The recycled materials were cut into small pieces, and then these pieces were placed in the heat press at 150° C. for 10 mins before cold press for another 10 mins to general recycled lignin-based plastic blend films. After sample conditioning, the tensile properties of the lignin-based film made from recycled plastic blend films were tested according to ISO37 standard.

### Sustainable Lignin-Based Plastic Characterizations and Testing

For surface morphology of lignin-based plastic blend films, an OLYMPUS BX60 polarized optical microscope was used to observe the morphologies of pure PMMA, PMMA/KL, and PMMA/HIMWELL blend films, respectively.

For the photoaging test, the customized fluorescent ultraviolet radiation system was built using two 100W/10R PHILIPS UV tubes according to the modified ATSM D4329-21 for the lignin-based plastic blend films. The samples were placed 10 cm above the sample sheets in the closed chamber at ambient temperature of 23±0.5° C. and relative humidity (RH) of 50±2% for 100 hours UV radiation. The photoaging test was shown in FIGS. 5A-5C.

The UV-VIS Hitachi H4100 spectrophotometer was used to measure the transmission of light at 220-2600 nm for pure PMMA, PMMA/KL, and PMMA/HIMWELL blend films, respectively. The UV-barrier property and transparency of the films were determined by measuring transmittance of light around 250 nm to 800 nm, respectively.

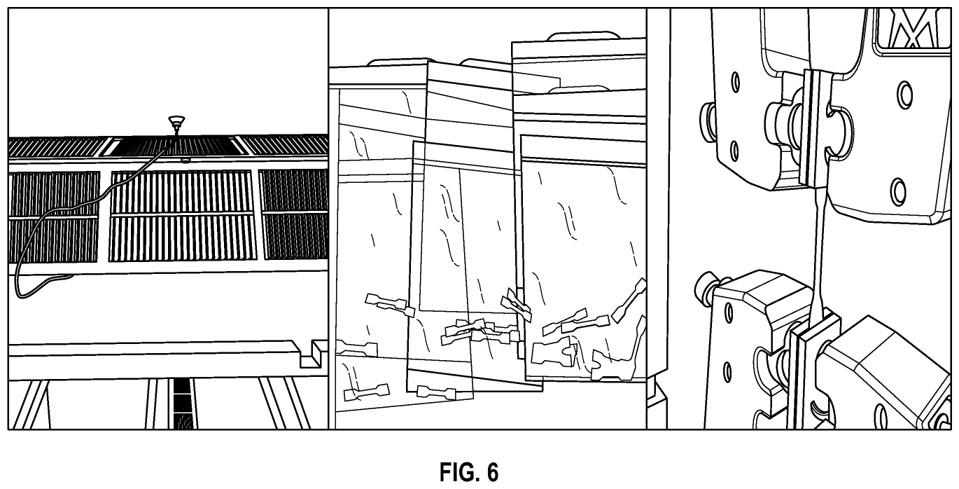

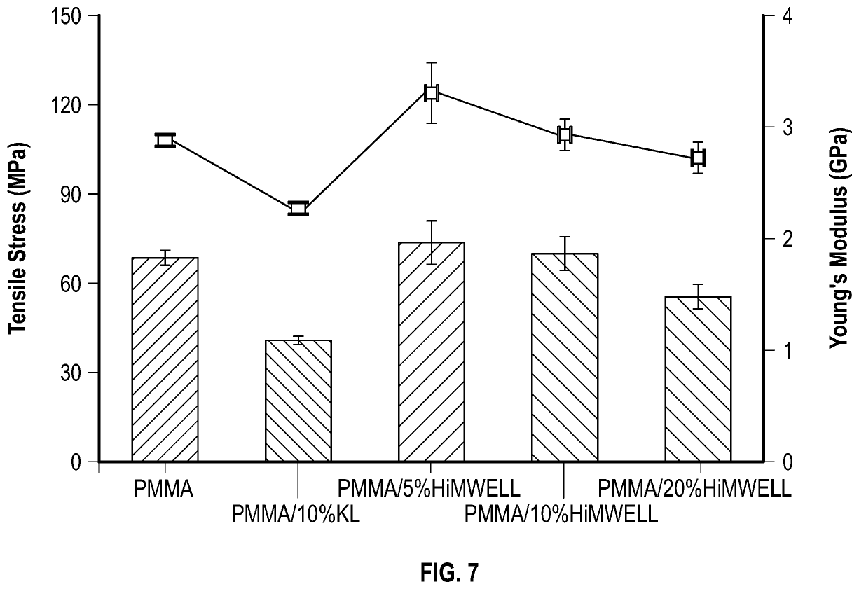

The tensile stress and Young's modulus of pure PMMA, PMMA/KL and PMMA/HIMWELL samples were tested by Instron universal mechanical testing machine with 500N load cell according to ISO37 standard. The tensile test samples were cut by the standard cutting die and testing speed rate was 1 mm/min. For each sample, the average of five replicates with a standard derivation was reported in FIG. 6. Table 1 provides the results obtained by comparing lignin samples treated with different acids. Table 2 provides quantitative results for samples subjected to ³¹P NMR analysis, ¹H NMR analysis, and HSQC NMR analysis. Table 3 provides a comparison of the mechanical properties of lignin-based carbon fibers which are presented graphically in FIG. 7. Table 4 gives the lignin yield for the lignin-based carbon fiber process.

TABLE 1

| | Aliphatic-OH | Phenolic-OH | Cross-linking | |
|---|---|---|---|---|
| Acid | reaction | reaction | reaction | Condensation |
| Inorganic acid | + | − | − | + |
| (Sulfuric acid) | | | | |
| Organic acid | − | − | − | − |
| (Azelaic acid) | | | | |
| Crotonic anhydride | + | + | + | − |

TABLE 2

| | AlOH^{a} | ArOH^{b} | COOH^{c} | δ6.0/δ | | | |
|---|---|---|---|---|---|---|---|
| Samples | (mmol/g) | (mmol/g) | (mmol/g) | 1.9^{d} | β-O-4^{e} | β-β^{f} | β-5^{g} |
| KL | 2.31 | 3.40 | 0.46 | n.a. | 14.6 | 2.7 | 3.6 |
| CTKL | 0.00 | 0.00 | 0.37 | 0.2922 | 11.4 | 3.0 | 2.2 |
| HiMWELL | 0.00 | 0.00 | 0.35 | 0.2822 | 12.4 | 3.2 | 2.0 |

^{a}Aliphatic hydroxyl group (AlOH).
^{b}Aromatic hydroxyl group (ArOH).
^{c}Carboxylic acid group (COOH).
^{d}Degree of unsaturation of carbon-carbon bond based on 1H NMR analysis.
^{e-g}Content (%) expressed based on percentage of each interunit linkage per 100 Ar units.

TABLE 3

| | | Lignin/ | | | | | | | | |
|---|---|---|---|---|---|---|---|---|---|---|
| | | blend | | Tensile (GPa) | | Stress Young's modulus (GPa) | | | | |
| Lignin | Blend | ratio | Method | Lig-CF^{a} | P-CF^{b} | Ratio ^{c} | Lig-CF | P-CF | Ratio | |
| Kraft | PAN | 1:1 | Wet spin | 1.4 | 1.3 | 1.080 | 89.8 | 87.7 | 1.024 | I |
| lignin | (MW150K) | | | | | | | | | |
| Kraft | PLA | 1:1 | Extrusion | 0.02 | 0.04 | 0.5 | 0.02 | 6.4 | 0.004 | C1 |
| lignin | | | | | | | | | | |
| Organo | PAN | 1:1 | Electro- | 0.02 | 0.04 | 0.5 | 2.4 | 6.4 | 0.375 | C2 |
| solv lignin | (MW150K) | | spin | | | | | | | |
| Hardwood | PAN | 1:1 | Wet spin | 0.47 | 0.45 | 1.042 | 40.4 | 40.5 | 0.998 | C3 |
| Lignin | (MW150K) | | | | | | | | | |
| Soda | PAN | 3:7 | Gel spin | 1.37 | 1.54 | 0.890 | 194 | 193 | 1.005 | C4 |
| lignin | (MW250k) | | | | | | | | | |
| Kraft | PAN | 1:1 | Wet spin | 1.2 | 1.38 | 0.870 | 105.7 | 155.2 | 0.681 | C5 |
| liinin | (MW233K) | | | | | | | | | |

Note:
^{a}represents lignin-based carbon fiber;
^{b}represents PAN carbon fiber;
^{c} represents the ratio of mechanical properties of the lignin-based carbon fiber to that of the PAN carbon fiber.
I = inventive
C = comparative

TABLE 4

| | Kraft lignin | Thermostablization | Carbonization |
|---|---|---|---|
| yields | 100% | 90.0% | 41.5% |

Note:
The yields calculated by the product weight and the raw kraft lignin weight.

While aspects of the presently disclosed subject matter have been shown and described, modifications thereof can be made by one skilled in the art without departing from the spirit and teachings of the subject matter. The aspects described herein are exemplary only, and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the presently disclosed subject matter. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A method of producing a high molecular weight esterified lignin comprising:
contacting a lignin composition obtained from a renewable resource with an aqueous fluid a plurality of times to produce a washed lignin;
contacting the washed lignin with an esterifying agent under conditions suitable for formation of an esterified lignin;
contacting the esterified lignin with a crosslinking agent under conditions suitable for the formation of a high molecular weight esterified lignin; and
recovering the high molecular weight esterified lignin.

2. The method of claim 1, wherein the lignin composition obtained from a renewable resource comprises corn stover, corn cobs, corn kernels, corn fibers, straw, banana plantation waste, rice straw, rice hull, oat straw, oat hull, corn fiber, cotton stalk, cotton gin, wheat straw, sugar cane bagasse, sugar cane trash, sorghum residues, sugar processing residues, barley straw, cereal straw, wheat straw, canola straw, soybean stover, or a combination thereof.

3. The method of claim 1, wherein the lignin composition obtained from a renewable resource comprises Kraft lignin, hard wood, soft wood, grasses, agricultural waste, agricultural material, municipal waste, or a combination thereof.

4. The method of claim 1, wherein the lignin composition obtained from a renewable resource is obtained from biorefinery waste, pulping waste, fermentation waste or a combination thereof.

5. The method of claim 1, further comprising pretreating the lignin composition obtained from a renewable resource.

6. The method of claim 5, wherein pretreating comprises thermo-chemical pretreatment, enzymatic hydrolysis, microbial fermentation, product separation, deacetylation and mechanical refining (DMR) pretreatment, ammonia fiber expansion (AFEX) pretreatment or combinations thereof.

7. The method of claim 1, wherein the lignin composition obtained from a renewable resource comprises Kraft lignin.

8. The method of claim 1, wherein the plurality of times is from about 1 to about 5.

9. The method of claim 1, wherein the esterifying agent is an organic anhydride.

10. The method of claim 1, wherein the organic anhydride comprises acetic anhydride, octanoic acid anhydride, n-octanoic anhydride, caprylic anhydride, n-caprylic anhydride, propionic anhydride, crotonic anhydride or a combination thereof.

11. The method of claim 1, wherein the crosslinking agent comprises 1-ethyl-3-[3-dimethylaminopropyl]carbodiimide hydrochloride (EDC), dicyclohexyl carbodiimide (DDC), N-hydroxysuccinimide esters (NHS), maleimides, or a combination thereof.

12. The method of claim 1, wherein the high molecular weight esterified lignin has a molecular weight of from about 4000 g/mol to about 20000 g/mol.

13. The method of claim 1, wherein the high molecular weight esterified lignin has a hydroxyl group content that is reduced by from about 0.3 mmol/g to about 10 mmol/g when compared the lignin composition obtained from a renewable resource.

14. A composition comprising:
(i) a polymeric material; and
(ii) a high molecular weight esterified lignin.

15. The composition of claim 14, wherein the polymeric material comprises low-density polyethylene (LDPE), high-density polyethylene (HDPE), polypropylene (PP), polyvinyl chloride (PVC), polystyrene (PS), polytetrafluoroethylene, thermoplastic polyurethanes (TPU), polyacrylonitrile or combinations thereof.

16. The composition of claim 14, wherein the polymeric material comprises low-density polyethylene (LDPE), high-density polyethylene (HDPE), polypropylene (PP), polyvinyl chloride (PVC), polystyrene (PS), polytetrafluoroethylene, thermoplastic polyurethanes (TPU), polyacrylonitrile or combinations thereof.

17. The composition of claim 14, wherein the polymeric material comprises polyacrylonitrile.

18. The composition of claim 14, wherein the high molecular weight esterified lignin has a molecular weight of from about 4000 g/mol to about 20000 g/mol.

19. The composition of claim 14, wherein the high molecular weight esterified lignin has a hydroxyl group content that is reduced by from about 0.3 mmol/g to about 10 mmol/g when compared the lignin composition obtained from a renewable resource.

20. A carbon fiber prepared from (i) a polymeric material and (ii) a high molecular weight esterified lignin.

21. The carbon fiber of claim 20, wherein the polymeric material comprises polyacrylonitrile.

22. The carbon fiber of claim 20, wherein the high molecular weight esterified lignin has a molecular weight of from about 4000 g/mol to about 20000 g/mol.

23. The carbon fiber of claim 20, wherein the carbon fiber has a Young's modulus of from about 1 GPa to about 3 GPa.

24. The carbon fiber of claim 20, wherein the carbon fiber has a tensile strength of from about 0.5 GPa to about 2 GPa.

25. An article prepared from the carbon fiber of claim 20.
